(19) United States
(12) Patent Application Publication
(10) Pub. No.: US 2008/0254175 A1
(43) Pub. Date: Oct. 16, 2008

(54) Method for Processing Liquid-Holdable Material Substance and Processor for Processing Liquid-Holdable Material Substance

(76) Inventor: Minoru Fujimoto, Seika-cho (JP)

Correspondence Address: CASELLA & HESPOS, 274 MADISON AVENUE, NEW YORK, NY, 10016, US

(21) Appl. No.: 10/586,145

(22) PCT Filed: Jan. 19, 2004
(86) PCT No.: PCT/JP04/00361

§ 371 Date: Jul. 14, 2006

(51) Int. Cl. A23F 5/00; A23N 12/00

(52) U.S. Cl. 426/281; 99/470

(57) ABSTRACT

A method for processing coffee beans (C), including the step of charging the coffee beans (C) in a vessel (10) and supplying water inside a vessel body (11) by spraying out water inside the vessel body (11) through an injection liquid charging channel (23) via a spray nozzle (23a) for allowing water to penetrate to the inside of the coffee beans (C) while the inside of the vessel body 11 is under pressure and heated, and the step of reducing the pressure inside the vessel body (11) for water having penetrated to the inside of the coffee beans (C) to expand by vaporization in grinding the coffee beans (C) that have been swollen in a porous manner using an expanding force.

### BACKGROUND OF THE INVENTION

1. Field of the Invention

The present invention relates to a method for processing a liquid-holdable material substance and a processor used for this processing method.

2. Description of the Related Art

As a method for applying processing, such as grinding, to a liquid-holdable material substance, such as beans represented by coffee beans, that can be impregnated with a liquid having vaporizability or a fluid in a super-critical state to the inside thereof, a conventional method chiefly performed is to pour the liquid-holdable material substance into a processing device equipped with a blade for the liquid-holdable material substance to be ground by rotating the blade.

In a case where the liquid-holdable material substance is processed using such a processing device, however, the inside of the liquid-holdable material substance cannot be made porous, and when one tries to extract the essence or the like of the liquid-holdable material substance later, one fails to extract the essence efficiently.

### SUMMARY OF THE INVENTION

The invention has therefore an object to provide a method and a processor for processing a liquid-holding porous material substance.

According to an aspect of the invention, a method for processing a liquid-holdable material substance comprises: impregnating a liquid-holdable material substance that can be impregnated with a liquid having vaporizability or a fluid in a super-critical state to an inside thereof with the liquid having vaporizability or the fluid in the super-critical state, and reducing a pressure inside a processing vessel while the liquid-holdable material substance is charged in the vessel for the liquid or the fluid in the super-critical state that has penetrated to the inside of the liquid-holdable material substance to expand by vaporization, thereby causing the liquid-holdable material substance to expand in a porous manner or grinding the liquid-holdable material substance that has been processed into a porous state using an expanding force.

### BRIEF DESCRIPTION OF THE DRAWINGS

FIG. 1 is a view schematically showing a processor according to one embodiment of the invention.

FIG. 2 is a cross section taken on line A-A of FIG. 1.

FIG. 3 is a block diagram showing a control portion of the processor according to one embodiment of the invention.

### DETAILED DESCRIPTION OF THE PREFERRED EMBODIMENT

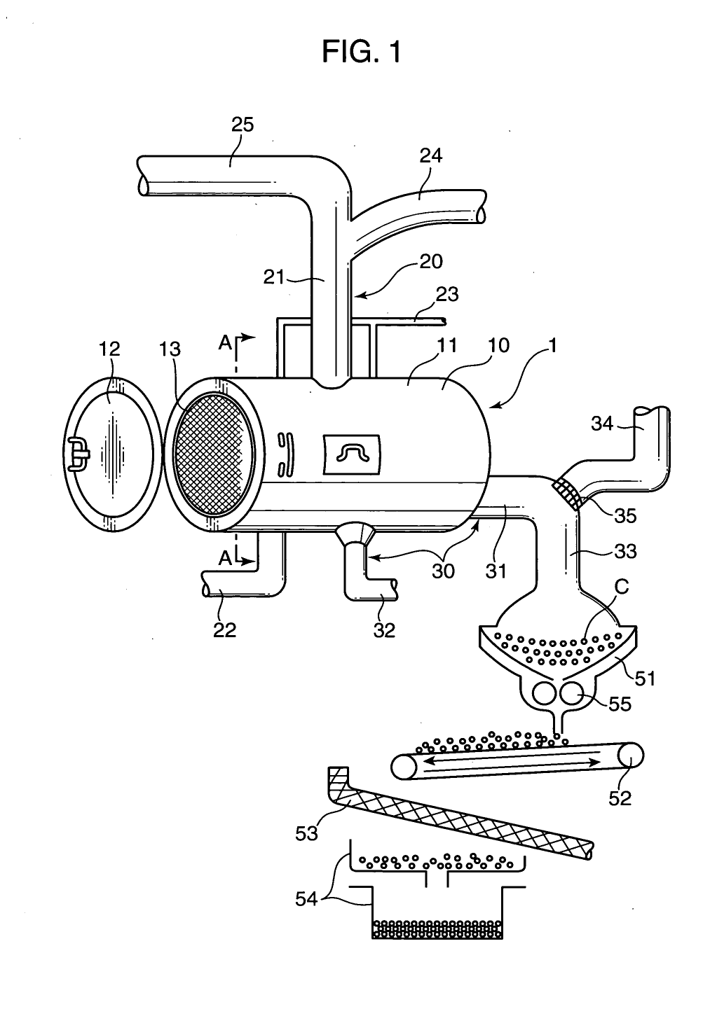

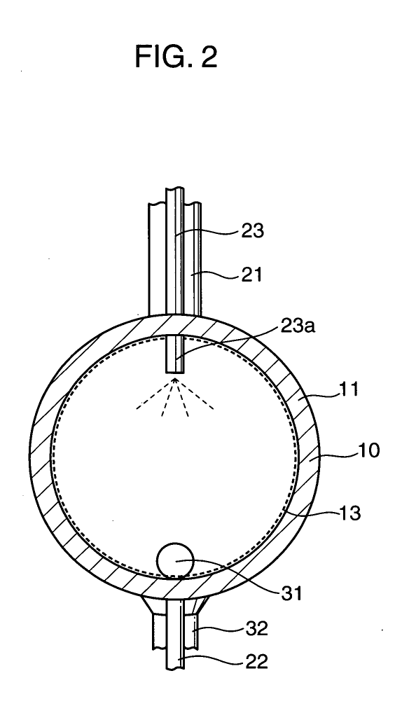

One embodiment of the invention will be described with the use of FIG. 1 and FIG. 2. FIG. 1 is a view schematically showing a processor according to this embodiment. FIG. 2 is a cross section taken on line A-A of FIG. 1. In this embodiment, coffee beans C are used as a liquid-holdable material substance.

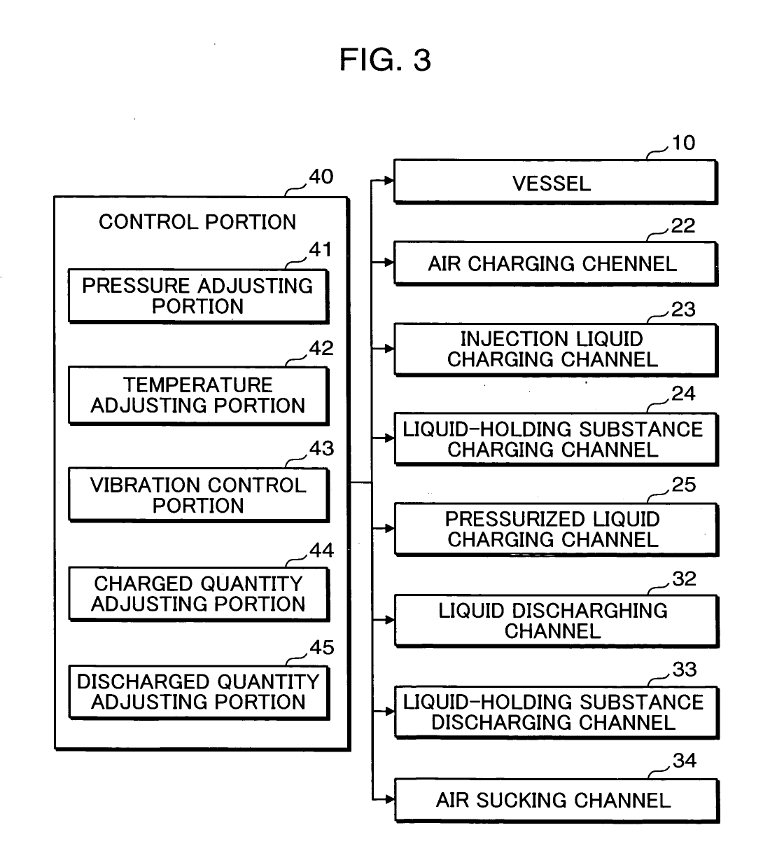

A processor 1 includes a vessel 10 into which a substance, such as coffee beans C, is charged, a charging channel 20 through which the substance, such as the coffee beans C, is charged in a space within the vessel 10, a discharging channel 30 through which the substance, such as the coffee beans C, is discharged from the inside of the vessel 10, and a control portion 40 (see FIG. 3) that controls the processor 1.

The vessel 10 includes a vessel body 11 that defines a space within for the substance, such as the coffee beans C, to be charged therein, a lid 12 capable of closing this space hermetically, and a heater (not shown).

The vessel body 11 is made in an almost cylindrical shape, and a net filter 13 is disposed to go along the inner circumference thereof.

The charging channel 20 includes a common charging channel 21 used for charging a pressurized liquid and the coffee beans C, an air charging channel 22 used for charging air pressurized by a compressor (not shown), and an injection liquid charging channel 23 used for feeding a liquid to be injected inside the vessel body 11, and each communicates with the space inside the vessel body 11. By disposing the aforementioned filter 13 at the communication portion of the air charging channel 22 and the vessel body 11, it is possible to prevent the coffee beans C from entering into the air charging channel 22 and the vessel body 11. Also, valves (not shown) are disposed at some midpoint in the common charging channel 21, the air charging channel 22, and the injection liquid charging channel 23.

The common charging channel 21 branches at some midpoint to a liquid-holdable material substance charging channel 24 used for charging the coffee beans C in the vessel body 11, and a pressurized liquid charging channel 25 used for charging a liquid pressurized by a compressor (not shown) or the like in the vessel body 11. The injection liquid charging channel 23 is provided with a compressor (not shown) for pressurizing the liquid and is also provided with an injection nozzle 23a at the tip end for spraying out the liquid inside the vessel body 11.

The discharging channel 30 includes a common discharging channel 31 used for discharging air and the coffee beans C present inside the vessel body 11 from the inside of the vessel body 11, and a liquid discharging channel 32 used for discharging a liquid present inside the vessel body 11 from the inside of the vessel body 11, and each communicates with the space inside the vessel body 11. By disposing the aforementioned filter 13 also at the communication portion of the liquid discharging channel 32 and the vessel body 11, it is possible to prevent the coffee beans C from entering into the liquid discharging channel 32 and the vessel body 11. Valves (not shown) are also disposed in the common discharging channel 31 and the liquid discharging channel 32.

The common discharging channel 31 branches at some midpoint to a liquid-holdable material substance discharging channel 33 used for discharging the coffee beans C from the inside of the vessel body 11, and an air sucking channel 34 provided with a vacuum pump (not shown) for sucking in air for discharging air inside the vessel body 11 by suction. Also, a barrier mesh 35 that prevents the coffee beans C from entering into the air sucking channel 34 is provided at the branching point to the liquid-holdable material substance discharging channel 33 and the air sucking channel 34.

Further, a grinder 51 that grinds the coffee beans C, a belt conveyer 52 that transports the coffee beans C, a sieve 53 used for sifting the coffee beans C through a sieve, and a reservoir container 54 that stores the coffee beans C are provided ahead of the liquid-holdable material substance discharging channel 33. The grinder 51 is provided with a grinding blade 55, and the coffee beans C transported to the grinder 51 are ground by the grinding blade 55.

The control portion that controls the processor 1 will now be described with the use of FIG. 3.

The control portion 40 includes a pressure adjusting portion 41, a temperature adjusting portion 42, a vibration control portion 43, a charged quantity adjusting portion 44, and a discharged quantity adjusting portion 45.

The pressure adjusting portion 41 is to adjust the pressure inside the vessel body 11 and the pressure of a fluid fed into the vessel 10, and it adjusts the pressure inside the vessel body 11 by adjusting the degree of opening of valves disposed in the common charging channel 21, the air charging channel 22, the injection liquid charging channel 23, and the common discharging channel 31 and by adjusting a quantity of air supplied through the air charging channel 22 and a quantity of air discharged through the air sucking channel 34. It also adjusts the pressure of a liquid fed through the injection liquid charging channel 23 by adjusting the compressors provided to the injection liquid charging channel 23 and the pressurized liquid charging channel 25.

The temperature adjusting portion 42 is to adjust the temperature inside the vessel body 11, and it adjusts the temperature inside the vessel body 11 by controlling the heater provided to the vessel 10 to heat or cool the inside of the vessel body 11.

The vibration control portion 43 is to cause the substance, such as the coffee beans C, charged in the vessel body 11 to vibrate, and it causes the substance present inside the vessel body 11 to vibrate by providing the substance inside the vessel body 11 with ultrasonic waves.

The charged quantity adjusting portion 44 adjusts the quantity of a substance charged in the vessel body 11 by adjusting quantities of air charged through the air charging channel 22, the coffee beans C charged in the vessel body 11 through the liquid-holdable material substance charging channel 24, and a liquid charged through the injection liquid charging channel 23 and the pressurized liquid charging channel 25.

The discharged quantity adjusting portion 45 adjusts the quantity of a substance discharged from the inside of the vessel body 11 by adjusting the degree of opening of the valves disposed in the common discharging channel 31 and the liquid discharging channel 32 and thereby adjusting quantities of a liquid discharged through the liquid discharging channel 32, the coffee beans C discharged through the liquid-holdable material substance discharging channel 33, and the quantity of air discharged through the air sucking channel 34.

Hereinafter, steps of processing the coffee beans C will be described. The lid 12 is open in FIG. 1; however, the lid 12 is in a closed state during the processing.

Step 1: The coffee beans C are fed into the vessel body 11 through the liquid-holdable material substance charging channel 24 by activating the charged quantity adjusting portion 44 while all the valves except for the valves disposed in the common charging channel 21 and the injection liquid charging channel 23 are kept closed by the pressure adjusting portion 41 and the discharged quantity adjusting portion 45.

Step 2: Water is fed into the vessel body 11 through the injection liquid charging channel 23 and the injection nozzle 23a for the water to penetrate to the inside of the coffee beans C while all the valves are kept closed by the pressure adjusting portion 41, that is, while the inside of the vessel body 11 is closed hermetically (penetration step). Also, when this penetration step is performed, penetration of water to the inside of the coffee beans C is promoted by activating the pressure adjusting portion 41 to open the valve disposed in the air charging channel 22 for air to be supplied through the air charging channel 22 in pressurizing the inside of the vessel body 11. Further, when the penetration step is performed, the temperature inside the vessel body 11 is increased by also activating the temperature adjusting portion 42 to roast the coffee beans C.

Step 3: The valve disposed in the common discharging channel 31 is opened by adjusting the pressure adjusting portion 41 and in the meantime the pressure inside the vessel body 11 is reduced by sucking air inside the vessel body 11 in a stroke through the air sucking channel 34. By adding vibrations to a substance present inside the vessel body 11, such as the coffee beans C, by the vibration control portion 43 almost simultaneously with this sucking operation, water having penetrated into the coffee beans C is allowed to vaporize abruptly, so that the coffee beans C are ground as they are expanded in a porous manner by expanding resulted from vaporization (depressurization step).

Step 4: A liquid or air having flavoring ingredients and seasoning ingredients is fed through the pressurized liquid charging channel 25, and the coffee beans C are impregnated with the liquid or air to the inside thereof (post-processing penetration step). Further, this penetration is promoted by supplying air through the air charging channel 22 while the pressure adjusting portion 41 is adjusted to keep pressurizing the inside of the vessel body 11.

Step 5: The coffee beans C present inside the vessel body 11 are discharged toward the liquid-holdable material substance discharging channel 33 via the common discharging channel 31 by adjusting the degree of opening of the valves disposed in the common discharging channel 31 and the liquid discharging channel 32 by the discharged quantity adjusting portion 45, and in the meantime the liquid present inside the vessel body 11 is discharged to the outside through the liquid discharging channel 32.

Step 6: The coffee beans C present in the liquid-holdable material substance discharging channel 33 are ground more finely using the grinder 51.

Step 7: The coffee beans C ground by the grinder 51 are transported to the sieve 53 by the belt conveyer 52, and the coffee beans C are put through the sieve 53 so that only the coffee beans C having a particle size inappropriate to be sealed in a tea-bag are stored in the reservoir container 54.

Step 8: The coffee beans C that were not stored in the reservoir container 54 are sealed in a tea-bag, and later packaged using a plastic bag or the like.

When the method described above is adopted, because the coffee beans C are expanded by vaporizing water while they are impregnated with water to the inside thereof, the coffee beans C can be processed in a porous state. It is therefore possible to produce coffee beans C from which the essence is readily extracted. Further, because this expanding can also grind the coffee beans C, it is possible to grind the coffee beans C using this method.

Additionally, because heating is also performed when the penetration step is performed, not only is it possible to process the coffee beans C into a porous state, but it is also possible to perform roasting. This eliminates the need to perform the roasting operation separately, which can in turn enhance the efficiency of the processing operation.

Further, when the depressurization step is performed, the substance present inside the vessel body 11, such as the coffee beans C, is vibrated by the vibration control portion 43, and this vibration triggers the expanding of water having penetrated into the coffee beans C, which makes it easier to grind the coffee beans C that have been expanded in a porous state. The processing operation can be therefore performed more efficiently.

Also, because the penetration step is performed while the inside of the vessel body 11 is under pressure, it is possible to allow water to penetrate into the coffee beans C more effectively.

Furthermore, because the coffee beans C are impregnated with a liquid or air having flavoring ingredients and seasoning ingredients to the inside thereof in the post-processing step, it is possible to enhance aroma and flavor of the coffee beans C.

While one embodiment of the invention has been described, the concrete configuration of the invention is not limited to the embodiment described above, and the invention can be modified in various manners within the scope of claims. Hereinafter, other embodiments will be described by way of example. In embodiments described below, like components are labeled with like reference numerals with respect to the embodiment above, and detailed descriptions are omitted.

In Step 2, water inside the vessel body 11 may be put into a critical state or in a super-critical state by adjusting the pressure adjusting portion 41 and the temperature adjusting portion 42. When water is put into a critical state, in particular, water is in a state where it vaporizes instantly upon application of slight vibrations. Water can therefore vaporize quickly when the pressure is reduced while vibrations are being added as in Step 3, which enables the coffee beans C to be made porous more efficiently.

A substance allowed to penetrate into the coffee beans C in Step 2 is not limited to water, and for example, any substance that can vaporize from a liquid (including those in a critical state) and a super-critical state, such as carbon dioxide, can be used.

When Step 2 is performed, an inert gas, such as argon and nitrogen excluding oxygen, may be supplied instead of supplying air through the air charging channel 22. In this case, it is possible to prevent oxidation of the coffee beans C caused by heating, and it is therefore possible to forestall deterioration in flavor and aroma.

A paste substance, such as gelatin and starch, may be coated on the surface of the coffee beans C after Step 4 is performed. In this case, flavoring ingredients and seasoning ingredients that have penetrated to the inside of the coffee beans C in Step 4 can be maintained within the coffee beans C. Hence, not only is it possible to maintain flavor and aroma of the coffee beans C, but it is also possible to prevent oxidation of the coffee beans C.

In addition, when this coating operation is also performed while the inside of the vessel body 11 is under pressure, it is possible to coat the paste substance while it is allowed to penetrate slightly to the inside of the coffee beans C. The aromatic ingredients and the seasoning ingredients that have penetrated to the inside of the coffee beans C can be therefore maintained more effectively.

The post-processing penetration step in Step 4 may be performed while vibrations are added to the coffee beans C by the vibration control portion 43. In this case, a liquid or gas that is allowed to penetrate into the coffee beans C is able to penetrate into the coffee beans C more effectively.

As the liquid or gas containing aromatic ingredients and seasoning ingredients used in Step 4, those that remain in a solid state at room temperature may be used. In this case, the inside of the vessel body 11 is heated by the temperature adjusting portion 42, so that the post-processing penetration step is performed while the solid is in a liquid or gaseous state. By solidifying the liquid or gas again inside the coffee beans C later by cooling, it is possible to maintain the flavoring ingredients and the seasoning ingredients within the coffee beans C.

When the coffee beans C are packaged in Step 8, an inert gas, such as nitrogen and argon, may be sealed in the bag. In this case, oxidation of the coffee beans C can be prevented, and it is therefore possible to forestall deterioration in flavor and aroma. When an inert gas is sealed, it may be sealed in the bag under pressure.

The penetration step and the depressurization step may be performed repetitively several times. By performing these steps repetitively, the coffee beans C that have been processed into a porous state can be ground in a more reliable manner.

The liquid-holdable material substance used in the invention is not limited to the coffee beans C. For example, fruits and seeds of foods, such as beans represented by soybeans and adzuki beans, cereals like rice and foxtail millet, and acorns, may be used as well.

Further, the liquid-holdable material substance may be Korean ginsengs, burdock roots, kudzu roots, barks and leaves of trees, and the like, which are used for drinking by making an infusion thereof, or used for food by processing the essence contained within, that is to say, those used for drinking and foods by extracting the essence within. In this case, by making the liquid-holdable material substance porous, the essence contained in the liquid-holdable material substance can be extracted efficiently.

Furthermore, the liquid-holdable material substance may be fragrant wood. In this case, by making the fragrant wood porous, more aromatic ingredients can be released to the outside.

In Step 3, the coffee beans C present inside the vessel body 11 may be discharged toward the liquid-holdable material substance discharging channel 33 simultaneously when depressurization is performed. In this case, because the depressurization step and the discharge of the coffee beans C can be performed simultaneously, the operation efficiency can be enhanced.

The coffee beans C used in the invention are not necessarily impregnated with water inside the vessel body 11. They may be impregnated with water before they are charged in the vessel body 11, so that they are charged in the vessel body 11 in this state. When the coffee beans C in this state are charged in the vessel body 11, the penetration step in Step 2 does not have to be performed.

Powdery coffee beans C having a particle size inappropriate to be sealed in a tea-bag and therefore stored in the reservoir container 54 may be put into a mill again to be changed to finer particles, so that they are used as ground beans or used as instant coffee. In this case, the yield of the coffee beans C can be enhanced, which can in turn increase the production efficiency.

By adopting the method as described above, because a liquid having vaporizability or a fluid in a super-critical state is expanded by vaporization while it has penetrated to the inside of the liquid-holdable material substance, it is possible to process the liquid-holdable material substance into a porous state. Further, it is also possible to grind the liquid-holdable material substance depending on a depressurization situation in the depressurization step.

The liquid referred to in this specification should be noted to include a fluid in a critical state.

In summary, a method for processing a liquid-holdable material substance comprises: impregnating a liquid-holdable material substance that can be impregnated with a liquid having vaporizability or a fluid in a super-critical state to an inside thereof with the liquid having vaporizability or the fluid in the super-critical state, and reducing a pressure inside a processing vessel while the liquid-holdable material substance is charged in the vessel for the liquid or the fluid in the super-critical state that has penetrated to the inside of the liquid-holdable material substance to expand by vaporization, thereby causing the liquid-holdable material substance to expand in a porous manner or grinding the liquid-holdable material substance that has been processed into a porous state using an expanding force.

Also, a method for processing a liquid-holdable material substance comprises: charging a liquid-holdable material substance that can be impregnated with a liquid having vaporizability or a fluid in a super-critical state to an inside thereof in a processing vessel; impregnating the liquid-holdable material substance with the liquid having vaporizability or the fluid in the super-critical state to the inside thereof; and reducing a pressure inside the vessel for the liquid or the fluid in the super-critical state having penetrated to the inside of the liquid-holdable material substance to expand by vaporization, thereby causing the liquid-holdable material substance to expand in a porous manner or grinding the liquid-holdable material substance that has been processed into a porous state using an expanding force.

With the method described above, because a liquid having vaporizability or a fluid in a super-critical state is expanded by vaporization while the liquid or the fluid has penetrated to the inside of the liquid-holdable material substance, it is possible to process the liquid-holdable material substance into a porous state. Further, it is also possible to grind the liquid-holdable material substance depending on a depressurization situation in the depressurization step. When the liquid-holdable material substance is coffee beans, in particular, by making the coffee beans porous, the subsequent extraction operation can be readily performed.

The liquid-holdable material substance may be heated when the penetration step is performed. Because heating is also performed when the penetration step is performed, the efficiency of the processing operation can be enhanced. In particular, when coffee beans are processed, not only can the coffee beans be processed to be porous or ground in a state having been processed to be porous, but also they can be roasted. This eliminates the need to perform the roasting operation separately, and it is therefore possible to enhance the processing operation.

The liquid-holdable material substance may be vibrated when the depressurization step is performed. The liquid-holdable material substance can be vibrated when the depressurization step is performed, and this vibration triggers expanding of the liquid or the fluid in the super-critical state having penetrated into the liquid-holdable material substance. The liquid or the fluid is therefore able to expand readily, which makes it easier to process the liquid-holdable material substance into a porous state. The processing operation can be therefore performed more efficiently.

An inside of the vessel may be under pressure when the penetration step is performed. Because the liquid or the fluid in a super-critical state is allowed to penetrate into the liquid-holdable material substance under pressure, the liquid or the fluid is able to penetrate into the liquid-holdable material substance more effectively.

The penetration step and the depressurization step may be performed repetitively several times. When the penetration step and the depressurization step are performed repetitively several times, the liquid-holdable material substance can be expanded in a porous manner or ground in a state having been processed to be porous in a more reliable manner.

It may be preferable that after the penetration step and the depressurization step are performed, a post-processing penetration step is performed to impregnate the liquid-holdable material substance with a post-processing fluid by placing an inside of the vessel under pressure in applying post-processing to the liquid-holdable material substance. A fluid used for applying the post-processing to the liquid-holdable material substance, for example, ingredients to add flavor and seasoning materials, becomes able to penetrate to the inside of the liquid-holdable material substance.

The liquid-holdable material substance may be heated at the time of the post-processing penetration step and the post-processing fluid is solidified later by performing a cooling step of cooling the liquid-holdable material substance after the post-processing penetration step ends, and a post-processing depressurization step of reducing a pressure inside the vessel is performed after the cooling step. Because the post-processing fluid is solidified while the post-processing fluid has penetrated into the liquid-holdable material substance, it is possible to maintain the ingredients contained in the post-processing fluid within the liquid-holdable material substance.

A processor that performs the above-mentioned method includes a vessel having a space within, and a pressure adjusting portion that performs at least depressurization by adjusting an inside of the vessel. With this configuration, by charging the liquid-holdable material substance in the vessel and by reducing the pressure inside the vessel using the pressure adjusting portion, the liquid having vaporizability or the fluid in the super-critical state having penetrated to the inside of the liquid-holdable material substance can be expanded by vaporization, which allows the liquid-holdable material substance to expand in a porous manner or makes it possible to grind the liquid-holdable material substance that has been processed into a porous state.

There may be further provided a temperature adjusting portion for performing at least one of heating and cooling the inside of the vessel. With this configuration, it is possible to adjust the temperature of a substance (the liquid-holdable material substance, the liquid or fluid allowed to penetrate to the inside of the liquid-holdable material substance, etc.) present inside the vessel when the liquid-holdable material substance is processed.

1. A method for processing a liquid-holdable material substance comprising:
impregnating a liquid-holdable material substance that can be impregnated with a liquid having vaporizability or a fluid in a super-critical state to an inside thereof with the liquid having vaporizability or the fluid in the super-critical state, and reducing a pressure inside a processing vessel while the liquid-holdable material substance is charged in the vessel for the liquid or the fluid in the super-critical state that has penetrated to the inside of the liquid-holdable material substance to expand by vaporization, thereby causing the liquid-holdable material substance to expand in a porous manner or grinding the liquid-holdable material substance that has been processed into a porous state using an expanding force.

2. A method for processing a liquid-holdable material substance comprising
charging a liquid-holdable material substance that can be impregnated with a liquid having vaporizability or a fluid in a super-critical state to an inside thereof in a processing vessel;
impregnating the liquid-holdable material substance with the liquid having vaporizability or the fluid in the super-critical state to the inside thereof; and
reducing a pressure inside the vessel for the liquid or the fluid in the super-critical state having penetrated to the inside of the liquid-holdable material substance to expand by vaporization, thereby causing the liquid-holdable material substance to expand in a porous manner or grinding the liquid-holdable material substance that has been processed into a porous state using an expanding force.

3. The method for processing a liquid-holdable material substance according to claim 2, wherein:
the liquid-holdable material substance is heated when the penetration step is performed.

4. The method for processing a liquid-holdable material substance according to claim 3, wherein:
the liquid-holdable material substance is vibrated when the depressurization step is performed.

5. The method for processing a liquid-holdable material substance according to claim 4, wherein:
an inside of the vessel is under pressure when the penetration step is performed.

6. The method for processing a liquid-holdable material substance according to claim 5, wherein:
the impregnating of the liquid-holdable material substance and the reducing of pressure are performed repetitively several times.

7. The method for processing a liquid-holdable material substance according to claim 6, wherein:
after the impregnating of the liquid-holdable material substance and the reducing of pressure are performed, impregnating the liquid-holdable material substance is performed with a post-processing fluid by placing an inside of the vessel under pressure in applying post-processing to the liquid-holdable material substance.

8. The method for processing a liquid-holdable material substance according to claim 7, wherein:
the liquid-holdable material substance is heated at the time of impregnating the liquid-holdable material substance with a post-processing fluid, and the post-processing fluid is solidified later by cooling the liquid-holdable material substance after the impregnating of the liquid-holdable material substance with a post-processing fluid ends, and reducing a pressure inside the vessel is performed after the cooling of the liquid-holdable material substance.

9. The method for processing a liquid-holdable material substance according to claim 1, wherein:
the liquid-holdable material substance is coffee beans.

10. A processor for processing a liquid-holdable material substance comprising:
a vessel for containing a liquid-holdable material substance that can be impregnated with a liquid having vaporizability or a fluid in a super-critical state to an inside thereof, the liquid-holdable material substance being impregnated with the liquid having vaporizability or the fluid in the super-critical state to the inside thereof; and
a pressure adjusting portion that performs at least depressurization by adjusting an inside of the vessel for the liquid or the fluid in the super-critical state having penetrated to the inside of the liquid-holdable material substance to expand by vaporization.

11. The processor according to claim 10, including:
a temperature adjusting portion that performs at least one of heating and cooling the inside of the vessel.

12. The method for processing a liquid-holdable material substance according to claim 1, wherein:
the liquid-holdable material substance is vibrated when the depressurization step is performed.

13. The method for processing a liquid-holdable material substance according to claim 2, wherein:
the liquid-holdable material substance is vibrated when the depressurization step is performed.

14. The method for processing a liquid-holdable material substance according to claim 1, wherein:
after the impregnating of the liquid-holdable material substance and the reducing of pressure are performed, impregnating the liquid-holdable material substance is performed with a post-processing fluid by placing an inside of the vessel under pressure in applying post-processing to the liquid-holdable material substance.

15. The method for processing a liquid-holdable material substance according to claim 2, wherein:
after the impregnating of the liquid-holdable material substance and the reducing of pressure are performed, impregnating the liquid-holdable material substance is performed with a post-processing fluid by placing an inside of the vessel under pressure in applying post-processing to the liquid-holdable material substance.

16. The method for processing a liquid-holdable material substance according to claim 2, wherein:
the liquid-holdable material substance is coffee beans.
